(19) United States
(12) Patent Application Publication
(10) Pub. No.: US 2024/0129122 A1
(43) Pub. Date: Apr. 18, 2024

(54) EFFICIENT ENCRYPTION IN STORAGE PROVIDING DATA-AT-REST ENCRYPTION AND DATA MIRRORING

(71) Applicant: Nebulon, Inc., Fremont, CA (US)

(72) Inventors: JONATHAN ANDREW MCDOWELL, Belfast (GB); Scott Wilson, Golden, CO (US)

(21) Appl. No.: 18/277,963

(22) PCT Filed: Feb. 24, 2022
(86) PCT No.: PCT/US22/17769

§ 371 Date: Aug. 18, 2023

Related U.S. Application Data
(60) Provisional application No. 63/153,091, filed on Feb. 24, 2021.

(51) Int. Cl. H04L 9/08

(52) U.S. Cl. CPC H04L 9/0894; H04L 9/0891

(57) ABSTRACT

A storage platform (100) with secured mirroring of data and data-at-rest encryption reduces repetitive encryption of data. A storage controller (120) is responsible for both encryption data-at-rest encryption and data encryption for transmissions to backup storage, allowing encryption to be only performed once within the storage platform (100). This reduces the amount of computation the storage platform (100) must perform, improving overall system performance.

### BACKGROUND

Modern storage systems frequently encrypt stored data to prevent theft of physical storage devices from also resulting in unauthorized access to the data stored on the stolen storage devices. Encryption of stored data is sometimes referred to as “data-at-rest” encryption and is commonly performed in and by the storage devices, e.g., solid-state drives (SSDs) and hard drives.

Some storage systems, which may or may not provide encrypted stored data, satisfy high data availability and/or reliability requirements through operation in some form of mirrored mode. For mirrored mode operation, data may be stored in two or more entirely separate physical locations within the storage system, usually on logically separate control devices or storage nodes. In such storage systems, the communications between the devices responsible for holding primary and backup copies of the data may be protected from data snooping and modification in flight either by use of private and secure communication network or by encryption of transmissions.

### BRIEF DESCRIPTION OF THE DRAWINGS

FIG. 1 shows a storage platform in accordance with an example of the present disclosure.

FIG. 2 shows a storage platform in accordance with an example of the present disclosure using a primary storage component to encrypt data once for primary storage, transmission, and backup storage.

FIG. 3 shows a storage platform in accordance with an example of the present disclosure using a backup storage component to encrypt data once for primary storage, transmission, and backup storage.

FIG. 4 shows a storage platform in accordance with an example of the present disclosure using a receiving storage component to encrypt data once for primary storage, transmission, and backup storage.

FIG. 5 is a flow diagram of a process in accordance with an example of the present disclosure for operating a storage platform providing mirroring, secure transmission, and data-at-rest encryption.

The drawings illustrate examples for the purpose of explanation and are not of the invention itself. Use of the same reference symbols in different figures indicates similar or identical items.

### DETAILED DESCRIPTION

In accordance with an aspect of the present disclosure, a storage platform with mirroring of data and data-at-rest encryption reduces repetitive encryption of data. In contrast, prior storage systems may require three or more separate encryptions of each block of data written to mirrored storage. For example, a primary storage node and a backup storage node in some prior storage systems have their own encryption keys and must separately encrypt their copy of the data written to the local physical storage devices, and a further encryption of the data is needed for the transmission over the network. In one example implementation of the present disclosure, a storage controller performs a single encryption for both data-at-rest encryption and secure transmissions, e.g., to a backup storage component. Encryption of incoming data may be performed only once within the storage platform. This reduces the amount of computation that the storage platform must perform, improving overall system performance, but requires secure handling of shared encryption keys.

In accordance with another aspect of the present disclosure, a storage platform takes advantage of the fact that both the data-at-rest protection and data transfers within the storage platform may employ the same encryption. The storage platform may encrypt incoming data at a single location, e.g., at the primary storage component for a mirrored volume. In this manner, the data need only be encrypted once, and the same encrypted data may be written on the primary and backup storage devices and transmitted over the data network of the storage platform. By utilizing a standard Authenticated Encryption with Associated Data (AEAD) mechanism, the communications of metadata required for the mirroring protocol can be encrypted separately, then the encrypted data included in the transmission with a cryptographic hash performed over the encrypted data and/or encrypted metadata to ensure that data and metadata cannot be modified when being transmitted over a network. AEAD can provide confidentiality, integrity, and authenticity and have high performance and power efficiency on current computing hardware.

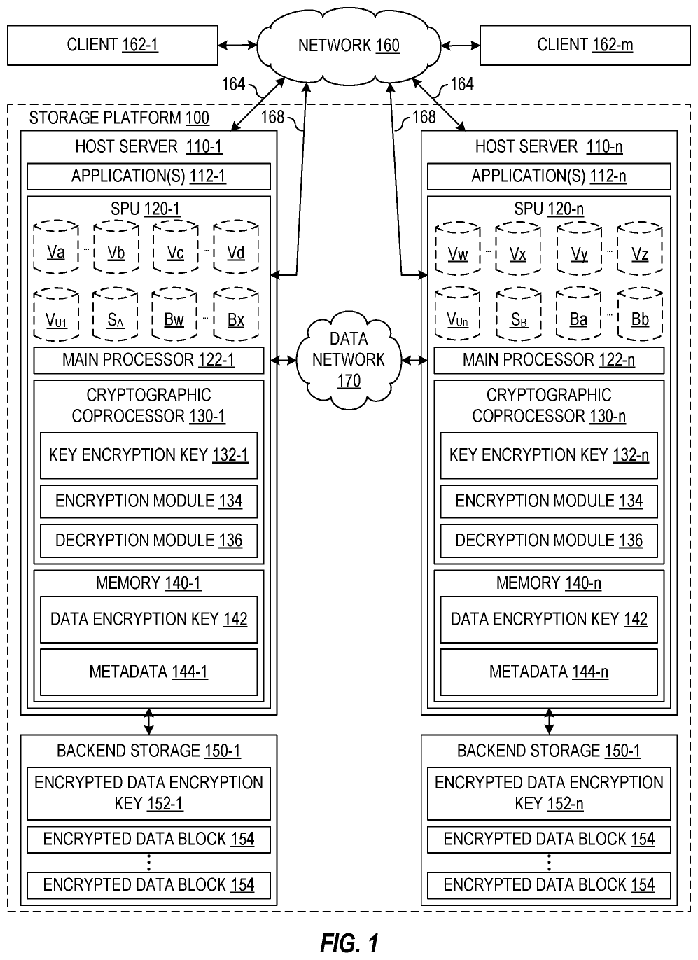

FIG. 1 is a block diagram illustrating a storage platform 100 in accordance with an example of the present disclosure. Storage platform 100 includes multiple host servers 110-1 to 110-n, which are generically referred to herein as host server(s) 110. Servers 110 are generally computers with hardware configured and programmed to provide resources, data, services, or programs to other computers or devices. Each host server 110 may include conventional computer hardware including a central processing unit (CPU), memory, and interfaces for connections to internal or external devices. Multiple service or storage processing units (SPUs) 120-1 to 120-n, which are generically referred to herein as SPU(s) 120, are installed in host servers 110. FIG. 1 illustrates only two servers 110-1 and 110-n, each including a single SPU 120-1 or 120-n. In general, storage platform 100 may include any number of host servers 110, with each server 110 hosting one or more SPUs 120. For redundancy, storage platform 100 may include at least two host servers 110 and at least at least two storage processing units 120. In general, storage platform 100 is scalable by adding more host servers 110 and SPUs 120 with associated backend storage 150.

SPUs 120-1 to 120-n are storage components that may respectively control or correspond to storage nodes of storage platform 100. Each SPU 120 may be a device installed and fully resident in the chassis of its associated host server 110. Each SPU 120 may, for example, be implemented with a card, e.g., a PCI-e card, or printed circuit board with a connector or contacts that plug into a slot in a standard peripheral interface, e.g., a PCI bus in host server 110. In the example of FIG. 1, SPUs 120-1 to 120-n respectively include main processors 122-1 to 122-n (sometimes generically referred to herein as main processors 122), cryptographic coprocessors 130-1 to 130-n (sometimes generically referred to herein as cryptographic coprocessors 130), and memory 140-1 to 140-n (sometimes generically referred to herein as memory 140). Each main processor 122 is configured or programed to enable SPUs 120 to process service requests or IO requests from clients.

SPUs 120 may particularly provide storage services to host servers 110, applications 112 running on servers 110, and network clients 162 via virtual volumes or logical unit numbers (LUNs). Each volume that an SPU 120 presents may be shared, meaning that the volume may be accessed through any server 110 or SPU 120 in platform 100, or may be unshared, meaning only the host server 110 containing the owning SPU 120 can access the volume. FIG. 1 particularly shows SPU 120-1 provides storage services relating to a set of shared volumes Va to Vb and Vc to Vd, and one or more unshared volumes V_{U1} and shows SPU 120-n provides storage services relating to shared volumes Vw to Vx and Vy to Vz, and one or more unshared volumes V_{Un}. SPU 120-1 is sometimes referred to as “owning” shared volumes Va to Vb and Vc to Vd in that SPU 120-1 is normally responsible for fulfilling input-output (IO) or service requests that are directed at any of volumes Va to Vb and Vc to Vd. Similarly, SPU 120-n owns shared volumes Vw to Vx and Vy to Vz in that SPU 120-n is normally responsible for executing service or IO requests that are directed at any of volumes Vw to Vx or Vy to Vz.

Any and all of volumes Va to Vb, Vc to Vd, V_{U1}, Vw to Vx, Vy to Vz, and V_{Un} are storage objects and may be generically referred to herein as base volumes V. In one example of the present disclosure, each base volume V includes multiple pages or blocks that are distinguished from each other by addresses or offsets within the base volume, and each base volume V may be a virtual volume in that the addresses or offsets are logical values that may not correspond to the physical locations where pages or blocks of data are physically stored in backend storage 150.

Each base volume V may be a “mirrored” volume having a backup volume B kept somewhere in storage platform 100. A base volume V that is mirrored is sometimes referred to herein as a primary volume V. In FIG. 1, SPU 120-1 maintains backup volumes Bw to Bx that copy primary volumes Vw to Vx that SPU 120-n owns, and SPU 120-n maintains backup volumes Ba to Bb that copy primary volumes Va to Vb that SPU 120-1 owns. One or more backup volumes Ba to Bb and Bw to Bx are sometimes generically referred to herein as backup volume(s) B. Backup volumes B may be virtual volumes that are copies of respective primary volumes V. Volumes Vc to Vd and Vy to Vz may be “unmirrored,” meaning volumes Vc to Vd and Vy to Vz do not have associated backup volumes or may be mirrored but have backup volumes maintained by storage components not expressly illustrated in FIG. 1. When storage platform 100 has more than two storage nodes or SPUs 120, the set of primary volumes owned by any one SPU 120 may have backup volumes distributed among the other SPUs 120 of the storage platform 100, which may reduce the effect if one of the SPUs 120 becomes unavailable.

SPUs 120-1 to 120-n may also maintain one or more unshared volumes V_{U1} to V_{Un} that are only used by their respective host servers 110. An SPU 120 may present an unshared volume V_{U1} or V_{Un}, for example, as a boot LUN for the host server 110 containing the SPU 120.

Each SPU 120 controls associated backend storage 150 for storage of data corresponding to shared and unshared volumes V that the SPU 120 owns and corresponding to backup volumes B that the SPU 120 maintains. In the example of FIG. 1, SPUs 120-1 operates storage 150-1 to store the data associated with primary volumes Va to Vb and Vc to Vd, backup volumes Bw to Bx, and any unshared volumes V_{U1}. SPUs 120-n operates storage 150-n to store the data associated with primary volumes Vw to Vx and Vy to Vz, backup volumes Ba to Bb, and any unshared volumes V_{Un}. Each component of storage 150 may be installed in the host server 110 containing an associated SPU 120, may include one or more external storage devices directly connected to its associate SPU 120 or host server 110, or may be network-connected storage. Storage 150 may employ, for example, hard disk drives, solid state drives, or other nonvolatile storage devices or media in which data may be physically stored, and storage 150 particularly may have a redundant array of independent disks (RAID) 5 or 6 configuration for performance and redundancy.

Storage platform 100 stores volume data as encrypted data blocks 154 and thereby provides data-at-rest encryptions. Accordingly, an unauthorized access backend storage 150 can only provide encrypted data. Encrypted data blocks 154 are encrypted using an encryption protocol and a data encryption key 142 that are shared throughout storage platform 100, so that any SPU 120 in platform 100 can decrypt any encrypted data block 154 that may have been encrypted by another SPU 120. In some examples, the encryption protocol may be a symmetric encryption protocol that uses the same data encryption key for encryption and decryption, and the Advanced Encryption Standard (AES) with Cipher Block Chaining (CBC) may be employed.

Multiple SPUs 120, e.g., SPU 120-1 to 120-n in FIG. 1, are connected using high speed data links, e.g., one or more parallel 10, 25, 50, 100 or more GB/s Ethernet links, to form a data network 170 for a “pod” of SPUs 120, e.g., interconnecting a cluster of storage nodes. Data network 170 may particularly be a high-speed data network that directly interconnects the SPUs 120 in a pod or cluster and may be independent of a user network 160 connecting host servers 110 and clients 162. Data network 170 being a dedicated network for storage platform 100 provides some security for transmissions. As described further below, storage platform 100 encrypts data and metadata before transmission so that a separate or secure network is not required.

Each SPU 120 further has a network connection 168 for communication through network 160. In some examples of storage platform 100, network 160 may include or connect to a wide area or public network, e.g., the Internet, so that SPUs 120 may communicate with cloud-based management infrastructure (not shown) that provides a cloud management plane for storage platform 100.

Servers 110 provide resources to clients 162 through network connections 164 and user network 160. In some examples, network 160 includes a local or private network or a public or wide area network, e.g., the Internet, and each client 162 may be a computer including a processor, memory, and software or firmware for executing a user interface adapted to communicate over local network 160. To receive storage services, a client 162 may communicate a service request to a host server 110 via network 160, and the host server 110 may communicate the service request to a resident SPU 120. In some other examples, an application 112 may be implemented in a host server 110, e.g., may run on the host server 110 to provide services to clients 162. An application 112 running on a server 110 may communicate a storage request to an SPU 120 resident in the server 110, e.g., via a driver or similar software or firmware component, and each application 112 does not need to communicate storage requests through network 160. The SPU 120 that receives a storage or other service request may or may not be the SPU that processes the request. For example, a service request targeting a particular volume V may need to be forwarded from the receiving SPU 120 to the SPU 120 that owns the volume V and executes the service request.

In accordance with an example of the present disclosure, a SPU 120 that receives a service request, e.g., a write request, including change data for a volume V may encrypt the change data before transmission or further processing of the change data. For example, the main processor 122 in an SPU 120 that receives a service request including data that changes a volume V may employ an encryption module 134 in its cryptographic processor 130 to encrypt the data received in a service request. Encryption module 134 encrypts the request data using a data encryption key 142. The encrypted data may be stored, e.g., as an encrypted data block 154, in associated backend storage 150 or may be safely transmitted to another SPU.

All SPUs 120 in storage platform 100 share the same data encryption key 142. Data encryption key 142 may be securely distributed to or updated in SPUs 120 using systems and methods such as described in PCT App. No. PCT/US2021/062876, entitled “Secure Distribution and Update of Encryption Keys in Cluster Storage.” In one specific example of the present disclosure, cryptographic coprocessor 130-1 to 130-n have a random/unique key encryption key 132-1 to 132-n, which may be stored in write-only memory for the cryptographic processor 130, so that each of key encryption keys 132-1 to 132-n is not accessible outside of the cryptographic coprocessor 130 containing the key. SPUs 120-1 to 120-n keep in respective persistent memory, e.g., associated backend storage 150-1 to 150-n, encrypted data encryption keys 152-1 to 152-n that result when encryption modules 134 encrypt the shared data encryption key 142 using their respective key encryption keys 142-1 to 142-n. Decryption modules 136 in cryptographic coprocessor 130-1 to 130-n can decrypt respective encrypted data encryption keys 152-1 to 152-n using respective key encryption keys 132-1 to 130-n to extract data encryption key 142, and each SPU 120 may only store data encryption key 142 in a volatile portion of its memory 140. As a result, data encryption key 142 cannot practically be obtained from an SPU 120 or associated backend storage 150 when the SPU 120 is not operating in storage platform 100.

The SPU owning an unmirrored volume V may process service requests targeting the unmirrored volumes V without communicating with a backup SPU 120. In one example of the present disclosure, an SPU 120 can receive a service request with unencrypted change data, e.g., a write request with a block of write data, targeting a data block at a request-specified address or offset in a request-specified unmirrored volume V that the SPU 120 owns. The main processor 122 in the SPU 120 owning the unmirrored volume V may then process such a service request by directing its cryptographic coprocessor 130 to use data encryption key 142 to encrypt the change data, store the resulting encrypted data block 154 in backend storage 150, and update metadata 144 in memory 140 of the SPU 120, e.g., to identify where the encrypted data block 154 for the request-specified address or offset and volume is physically stored in backend storage 150. When a later service request, e.g., a read request, requires data from a request-specified address or offset in a request-specified volume that an SPU 120 owns, the SPU 120 can use its metadata 144 to locate and read the correct encrypted data block 154 from associated backend storage 150, and decryption module 136 can use data encryption key 142 to decrypt the data block 154 read and reproduce the block of unencrypted data.

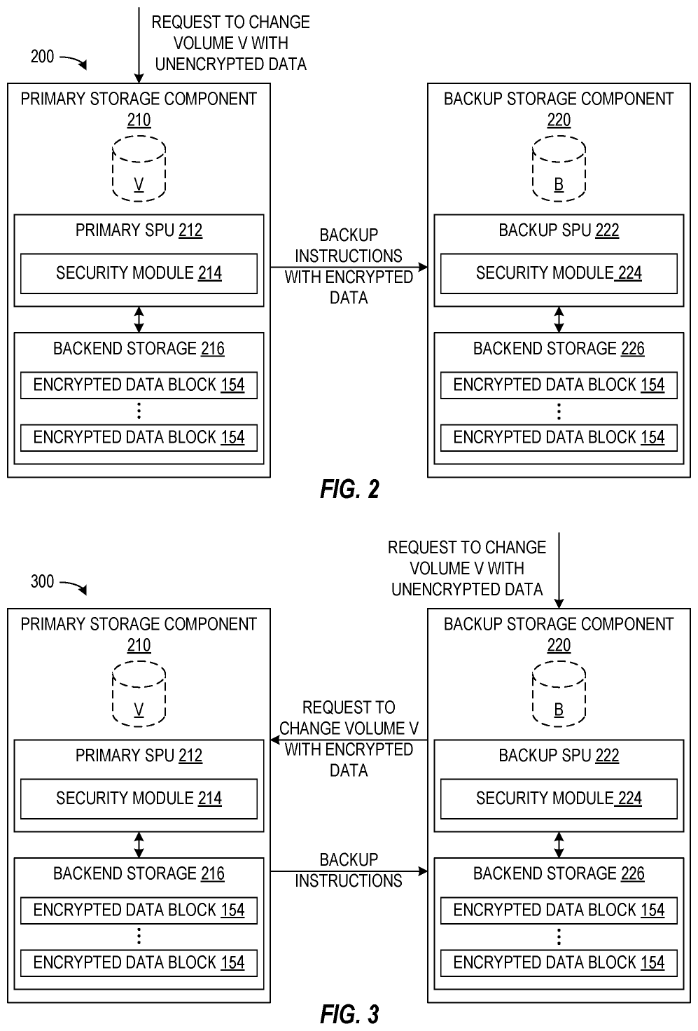

FIG. 2 illustrates an example of a storage platform 200 in accordance with an example of the present disclosure executing an example service request that changes data in a mirrored volume V. Storage platform 200 may be a cluster storage system that includes multiple storage components or nodes including a primary storage component 210 that owns the mirrored primary volume V, meaning that storage component 210 process normally service requests, e.g., read and write requests, directed at virtual volume V. A storage component 220 maintains a backup volume B that mirrors the content of primary volume V. With this arrangement, if primary storage component 210 fails or becomes unavailable, backup storage component 220 can use data associated backup volume B to take over responsibility for service requests directed at primary volume V.

Storage platform 200 maintains volume B as an accurate backup of primary volume V by having primary storage component 210 instruct backup storage component 220 to backup any service requests that change data in primary volume V. In response, backup storage component 220 can replicate the data change on backup volume B. In accordance with an aspect of the current disclosure, primary storage component 210 includes an SPU 212 that has a security module 214 capable of encrypting data using a private key, e.g., a data encryption key associated with storage platform 200. (In one example of the present disclosure, each storage component 210 and 220 may be similar or identical to an SPU 120 as described above with reference to FIG. 1.) When primary storage component 210 receives a service request including change data to be written to primary volume V, SPU 212 uses security module 214 to encrypt the change data before storing the encrypted data block 154 in associated backend storage 216. Backend storage 216 includes devices such as SSDs, hard drives, or other storage devices capable of physically storing data.

Primary storage module 210 may also send backup instructions to backup storage component 220. The backup instructions may include the encrypted change data, which SPU 212 encrypted, and metadata, e.g., a header or footer, identifying primary volume V or backup volume B and an address or offset associated with the change data. Primary storage 210 may use an AEAD procedure to encrypt a header, footer, or other metadata associated with the transmission to backup storage component 220 separately from the already encrypted data, and the AEAD procedure may include a hash of the encrypted metadata and the encrypted data in the transmission so that the transmission may be authenticated or tampering may be detected. The AEAD procedure does not need to encrypt the already encrypted data and may therefore treat the encrypted data as associated data with the encrypted metadata. As a result, the transmission does not include unencrypted data, making the transmission to backup storage component 220 secure.

SPU 222 in backup storage component 220 can receive the backup instructions, use a platform-wide key to decrypt (if necessary) the metadata, and then implement the backup instructions from primary storage component 210. SPU 222 can particularly store the already-encrypted data for backup volume B in backend storage 226 associated with backup SPU 222. The backed-up data in backend storage 228 is thus secured by the encryption that the primary SPU 212 performed. SPU 222 of backup storage component 220 may have a security module identical to the security module in primary SPU 212 so that backup storage component 220 is able to assume primary storage duties for a volume V including encryption and decryption of encrypted data blocks 154 if primary storage component 210 becomes unavailable.

FIG. 3 illustrates an example system 300 in which the storage component 220 that maintains the backup volume B for primary volume V receives from a client a request to change the volume V. In this example, backup storage component 220 encrypts the change data received from the client, and forwards to the primary storage component 210 a modified service request that includes the encrypted change data in place of the unencrypted change data from the storage client. Additionally, metadata, e.g., a header, of the modified service request may be encrypted using an AEAD procedure, such as described above, to encrypt the metadata, include a hash for authentication of the metadata and encrypted data, and to treat the encrypted data as associated data that is not further encrypted. Primary storage component 210 can then process the service request and may transmit backup instructions back to backup storage component 222 if primary storage component 210 determines a change to backup volume B is needed. The backup instructions may be encrypted using an AEAD procedure as described above. The backup instructions may include the encrypted data or backup storage component 220 may have temporarily kept a copy of the encrypted data. In either case, backup storage component 220 performs the backup operation upon receiving the backup instructions from primary storage component 210.

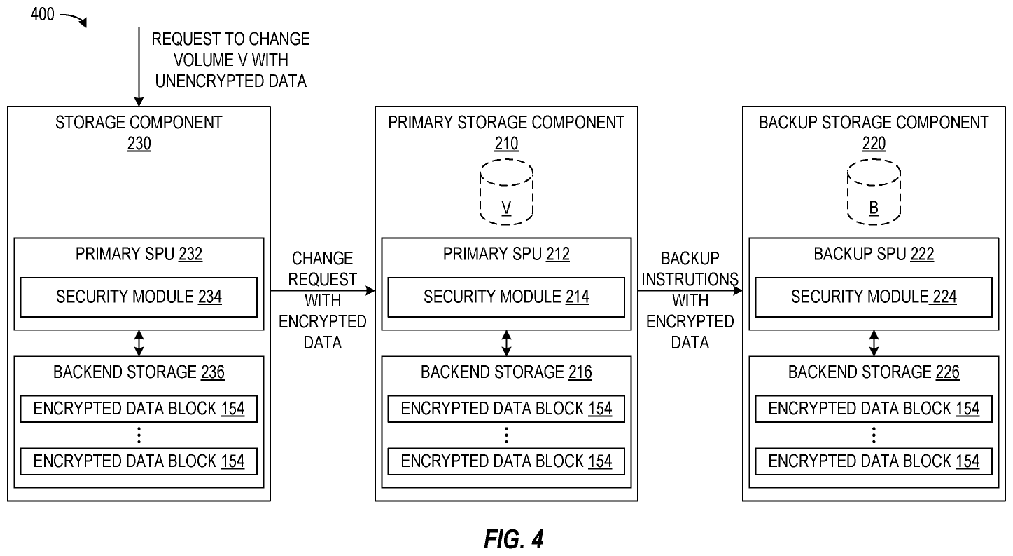

FIG. 4 illustrates an example system 400 in which a storage component 230 that does not own primary volume V or maintain the backup volume B for primary volume V receives from a client a request to change the volume V. In this example, storage component 230 encrypts the change data received from the client, and forwards to the primary storage component 210 a modified service request that includes the encrypted change data in place of the unencrypted change data from the storage client. Again, metadata, e.g., a header, of the modified service request may be encrypted using an AEAD procedure to encrypt the metadata and include a hash for authentication of the metadata and encrypted data, and that treats the encrypted data as associated data that does not require encryption before transmission. Primary storage component 210 can then process the service request and may transmit backup instructions to backup storage component 220 if primary storage component 210 determines a change to backup volume B is needed. The backup instructions transmitted to backup storage component 220 may be the same as described above but in this case needs to include the encrypted data, so that backup storage component 220 can perform the needed backup operation upon receiving the backup instructions from primary storage component 210.

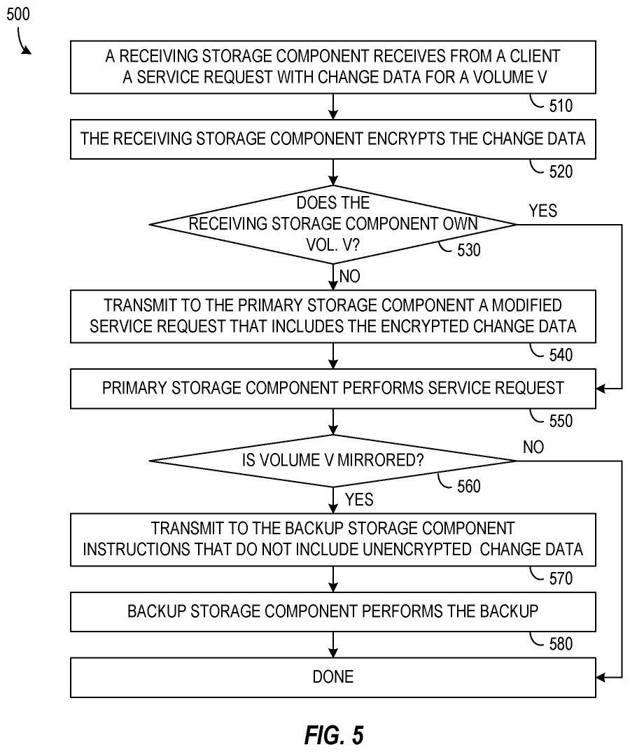

FIG. 5 is a flow diagram of a process 500 for a storage platform to fulfill service requests. To initiate process 500, a storage component in a process 510 receives from a storage client a service request that includes change data for changing at least a portion of a volume V. The change data may be raw data that is unencrypted. The receiving storage component in an encryption process 520 can then encrypt the change data using a data encryption key that is securely shared by all storage components in the storage platform.

The receiving storage component in a decision process 530, which may occur before or after encryption process 520 is started or completed, determines which storage component in the storage platform owns the target volume V. If the receiving storage component owns the target volume V, process 500 jumps to a storage process 550. If decision process 530 determines that the receiving storage component does not own the target volume, a transmission process 540 transmits from the receiving storage component to the primary storage component a modified service request that at least replaces the change data from the client with the encrypted change data and may also use an AEAD procedure. Accordingly, transmission process 540 does not transmit any unencrypted change data, and the transmission is secure. After the primary storage component receives the service request from the receiving storage component or after the receiving storage component identifies itself as being the primary storage component, the primary storage component performs the storage process 550 identified in the service request. For example, for a write request, the primary storage component performs a write operation that ensures the encrypted change data is physically stored somewhere in backend storage and can be identified as corresponding to a specific address or offset in the target volume V.

The target volume V may be a mirrored or unmirrored volume. If a decision process 560 determines the target volume V is unmirrored, the service request and process 500 is done. If a decision process 560 determines the target volume V is mirrored, the primary storage component identifies the backup storage component, and a transmission process 570 sends backup instructions to the backup storage component. The backup instructions may include the encrypted change data or instructions for backup storage component to identify or obtain the encrypted change data. For example, the backup storage component may already have the encrypted change data if the backup storage component is also the receiving storage component. Alternatively, the receiving storage component may have already transmitted the encrypted change data to the backup storage component, e.g., during transmission process 540. Once the backup storage component has the backup instructions from the primary storage component and has the encrypted change data (from whatever source), the backup storage component performs a backup process 580. For example, the backup storage component performs a write operation to the backup volume.

A benefit of the disclosed systems and methods is that one encryption process can secure stored primary data, secure communications of the data between storage components in a storage platform, and secure backup data. As an extra benefit, the fact that data is transmitted in the encrypted form that is written to the backend storage means that the storage components that receive data from other storage components do not need to perform any additional processing on the data to provide the secure storage, e.g., data-at-rest encryption.

Each of the modules disclosed herein may include, for example, hardware devices including electronic circuitry for implementing the functionality described herein. In addition, or as an alternative, each module may be partly or fully implemented by a processor executing instructions encoded on a machine-readable storage medium.

All or portions of some of the above-described systems and methods can be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although particular implementations have been disclosed, these implementations are only examples and should not be taken as limitations. Various adaptations and combinations of features of the implementations disclosed are within the scope of the following claims.

What is claimed is:

1. A process comprising:
a receiving storage component in a storage platform receiving from a client a service request and data for a change to a primary volume;
the receiving storage component encrypting the data to produce encrypted data;
a primary storage component in the storage platform storing the encrypted data to the primary volume, the primary storage component being responsible for performing service requests targeting the primary volume;
the primary storage component transmitting backup instructions, not including the data, to a backup storage component that is responsible for maintaining a backup copy of the primary volume; and
the backup storage component receiving the backup instructions and in response, storing the encrypted data to the backup storage component.

2. The process of claim 1, wherein:
the receiving storage component is the primary storage component; and
the primary storage component transmits the encrypted data to the backup storage component with the backup instructions.

3. The process of claim 1, wherein the receiving storage component is not the primary storage component, and the process further comprises the receiving storage component transmitting a modified service request to the primary storage component, the modified service request including the encrypted data but not including the data.

4. The process of claim 3, wherein the first storage component is neither the primary storage component nor the backup storage component, and the backup instructions include the encrypted data from the receiving storage component.

5. The process of claim 3, wherein
the first storage component is the backup storage component;
the backup storage component retains the encrypted data after transmitting the encrypted data to the primary storage component; and
the backup instructions do not include the data and do not include the encrypted data.

6. The process of claim 3, wherein the modified service request includes metadata identifying a service requested by the service request, and the metadata is encrypted separately from the data.

7. The process of claim 6, wherein the metadata is encrypted using an Authenticated Encryption with Associated Data (AEAD) process that treats the encrypted data as associated data that is authenticated but not further encrypted.

8. The process of claim 1, wherein the primary volume is a virtual volume, and the primary storage component storing the encrypted data comprises the primary storage component recording where the encrypted data may be found in backend media associated with the primary storage component.

9. The process of claim 1, wherein:
the primary storage component comprises a first processing unit that is resident in a first server and controls first backend media storing content associated with the primary volume; and
the backup storage component comprises a second processing unit that is resident in a second server and controls second backend media storing content associated with the backup volume.

10. The process of claim 9, wherein the primary storage component transmits the backup instructions through a data network to the backup storage component.

11. The process of claim 10, wherein only the receiving storage component encrypts the data through transmission of the encrypted data on the data network and storage of the encrypted data to the primary volume and the backup volume.
